(19) United States
(12) Patent Application Publication
(10) Pub. No.: US 2006/0251806 A1
(43) Pub. Date: Nov. 9, 2006

(54) Method of securing elastic strands to flat substrates and apparatus therefor

(75) Inventors: Reuben F. Brock, Suwanee, GA (US); Raza Hayder, Duluth, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 11/276,736

(22) Filed: Mar. 13, 2006

Related U.S. Application Data
(63) Continuation of application No. 10/619,069, filed on Jul. 14, 2003, now abandoned.
Application No. 10/619,069 is a continuation-in-part of application No. 10/283,690, filed on Oct. 30, 2002, now abandoned.
(60) Provisional application No. 60/364,811, filed on Mar. 15, 2002.

(51) Int. Cl. B05D 5/10

(52) U.S. Cl. 427/207.1; 427/434.2; 118/234

(57) ABSTRACT

Apparatus for dispensing adhesive onto a strand moving along a strand path includes an adhesive dispenser capable of receiving adhesive from an adhesive supply and having an upper end and a lower end. A nozzle is coupled to the lower end and is in fluid communication with the adhesive dispenser. The nozzle includes an adhesive discharge orifice for discharging the adhesive onto the strand moving along the strand path. A strand guide is mounted at a location proximate the lower end of the adhesive dispenser and upstream of the adhesive discharge orifice along the strand path. The strand guide is configured to receive and guide movement of the strand in spaced relation to the adhesive discharge orifice.

### CROSS-REFERENCE TO RELATED APPLICATIONS

This application is a continuation of application Ser. No. 10/619,069, filed Jul. 14, 2003 (pending) which is a continuation of application Ser. No. 10/283,690 filed on Oct. 30, 2002 (abandoned) which claims the benefit of Provisional Application Ser. No. 60/364,811 filed on Mar. 15, 2002 (abandoned), the disclosures of which are hereby incorporated by reference herein.

### FIELD OF THE INVENTION

The present invention generally relates to technology associated with securing elastic strands to flat substrates and, more particularly, to the high speed securement of elastic strands to substrates such as those used in producing hygienic articles such as diapers.

### BACKGROUND OF THE INVENTION

In various types of manufacturing operations, it is necessary to bond thin elastic strands to one or more sheets of material, such as woven or nonwoven materials. This practice is especially prevalent in the area of hygienic article manufacture, such as during the manufacture of diapers. Diaper manufacturing involves the application of fiberized adhesives, including temperature and/or pressure sensitive adhesives, onto flat substrates and stretched elastic strands, for example, in the areas of the waistband, leg cuffs, and standing leg gathers of the diapers. In these situations, it has been common practice to dispense continuous adhesive fibers or filaments onto either single elastic strands or multiple elastic strands at the same time, either before or after the strand has been laid against the substrate, to bond the strand(s) to the substrate(s). In this manner, overlapping portions of the same material may be bonded together with the stretched elastic strand(s) secured therebetween or two distinctly different substrates may be bonded together with the stretched elastic strand secured therebetween. This is a popular manner to elasticize specific areas of an article comprised of at least one flat substrate.

One type of adhesive dispenser which has been used extensively for bonding one or more elastic strands to one or more flat substrates is Controlled Fiberization™ (CF™) technology. This well known technique imparts a generally back and forth motion to a dispensed filament of adhesive in the preferred form of a swirl by impacting the filament with a plurality of jets of air. In this manner, a wider region of a substrate may be covered with adhesive dispensed from a single discharge orifice of a nozzle. The width of the adhesive pattern placed on the substrate may be widened to many times the width of the adhesive filament itself. Controlled Fiberization techniques have also been used to secure single or multiple strands of elastic to a flat substrate by dispensing the adhesive onto the strand(s) of elastic while the strand(s) are separated from the substrate. In this manner, the adhesive filament wraps itself around the strand(s) of elastic prior to joining the elastic strand(s) to the substrate thus providing a stronger bond between the elastic strands and the substrate.

Other adhesive filament dispensing techniques and apparatus have been used for producing vacillating generally sinusoidal pattern of adhesive on a substrate or, for example, a stitching pattern in which the adhesive moves back and forth generally in a sinusoidal or a zigzag motion on the substrate. Still other elastic strand securing methods include extruding a continuous layer of adhesive onto the strand after the strand has contacted the substrate. Various meltblowing techniques have also been used which essentially use randomly dispersed filaments of adhesive discharged onto one or more elastic strands either before or after the elastic strands have contacted the substrate.

Some of the main goals in this area of technology relate to achieving the necessary bond strength between the elastic strands and the substrates while at the same time transferring the desired elastic properties of the strands to the substrates. Another goal is to use as little adhesive as possible while still achieving the necessary bond strength and elastic characteristics. In addition to undesirable cost increase, using too much adhesive tends to stiffen the substrate and reduce the elastic properties of the strand(s). This latter effect leads to reduced elasticity in critical areas of the diaper, such as the waistband, leg cuffs, and standing leg gathers. In addition, large fiber patterns may obstruct the communication of moisture between layers, such as between an inner layer and an absorbent outer layer.

For these and other reasons, it would be desirable to provide a method of securing one or more elastic strands to a flat substrate or sheet in a manner suitable for a high speed manufacturing environment, while also achieving the necessary bond strength, creep resistance, efficient use of adhesive, and optimization of other desired characteristics of the resulting product.

### SUMMARY OF INVENTION

The present invention generally provides apparatus for dispensing adhesive onto a strand moving along a strand path and guided by a strand guide placed along the strand path. In one aspect, the apparatus comprises an adhesive dispenser capable of receiving adhesive from an adhesive supply and having an upper end and a lower end. A nozzle is coupled to the lower end of the adhesive dispenser and is in fluid communication with the adhesive dispenser. The nozzle includes an adhesive discharge orifice for discharging the adhesive received from the adhesive dispenser onto the strand moving past the adhesive discharge orifice along the strand path. A strand guide is mounted at a location beneath the lower end of the adhesive dispenser and upstream of the adhesive discharge orifice along the strand path. The strand guide is configured to receive and guide movement of the strand in spaced relation to the adhesive discharge orifice.

In another aspect, the apparatus comprises an adhesive dispenser capable of receiving adhesive from an adhesive supply and having an upper end, a lower end, a front side, and a rear side. The front side is located upstream of the rear side along the strand path. The apparatus includes a nozzle as summarized above, and also includes a strand guide mounted at a location directly adjacent the front side of the adhesive dispenser and upstream of the adhesive discharge orifice along the strand path. Again, the strand guide is configured to receive and guide movement of the strand in spaced relation to the adhesive discharge orifice.

The invention further contemplates methods of dispensing adhesive onto at least one strand from a dispensing nozzle coupled with an adhesive dispenser. Generally, the methods include moving the strand relative to the dispensing nozzle along a strand path and guiding the strand in spaced relation to the adhesive discharge orifice in a strand guide coupled beneath the adhesive dispenser at a location upstream of the adhesive discharge orifice along the strand path. Adhesive is dispensed from the adhesive discharge orifice toward the strand as the strand moves past the adhesive discharge orifice along the strand path, and the adhesive is then deposited on the strand. In another aspect, the strand is guided in spaced relation to the adhesive discharge orifice in a strand guide coupled at a location directly adjacent the front side of the adhesive dispenser and upstream of the adhesive discharge orifice along the strand path. In other aspects of the method, multiple strands may be guided in respective multiple slots in the strand guide.

These and other features, objects and advantages of the invention will be more readily apparent to those of ordinary skill in the art upon review of the following detailed description of the preferred embodiments, taken in conjunction with the accompanying drawings.

### BRIEF DESCRIPTION OF DRAWINGS

FIG. 1 is a schematic elevational view illustrating a method for intermittently applying adhesive segments to one or more elastic strands prior to joining the elastic strands with a flat substrate.

FIG. 2 is a schematic view similar to FIG. 1, but illustrating a method of intermittently applying elongate segments of adhesive after the elastic strand has contacted one surface of the flat substrate.

FIG. 3 is a top view illustrating the preferred adhesive pattern of intermittent, discrete and separated elongate segments of adhesive on multiple elastic strands.

FIG. 4 is a fragmented front elevational view showing the nozzle portion of a slot nozzle dispenser for intermittently applying elongate segments of adhesive onto three elastic strands.

FIG. 5 is a bottom view of the slot nozzle shown in FIG. 4, but with the strand guide removed for clarity.

FIG. 6 is a cross sectional view taken along lines 6-6 of FIG. 4 illustrating the method of applying discrete elongate segments of adhesive onto the moving elastic strand.

FIG. 7 is a cross sectional view of the strand and adhesive segment taken along line 7-7 of FIG. 6.

FIG. 8 is a fragmented front elevational view showing the nozzle portion of an alternative slot nozzle dispenser for intermittently applying elongate segments of adhesive onto three elastic strands.

FIG. 9 is a bottom view of the slot nozzle shown in FIG. 8, but with the strand guide removed for clarity.

FIG. 10 is a cross sectional view taken along lines 10-10 of FIG. 8 illustrating the method of applying discrete elongate segments of adhesive onto the moving elastic strand.

### DETAILED DESCRIPTION OF THE PREFERRED EMBODIMENTS

For purposes of this description, words of direction such as “upward”, “vertical”, “horizontal”, “right”, “left” and the like are applied in conjunction with the drawings for purposes of clarity in the present description only. As is well known, liquid dispensing devices may be oriented in substantially any orientation, so these directional words should not be used to imply any particular absolute directions for an apparatus consistent with the invention.

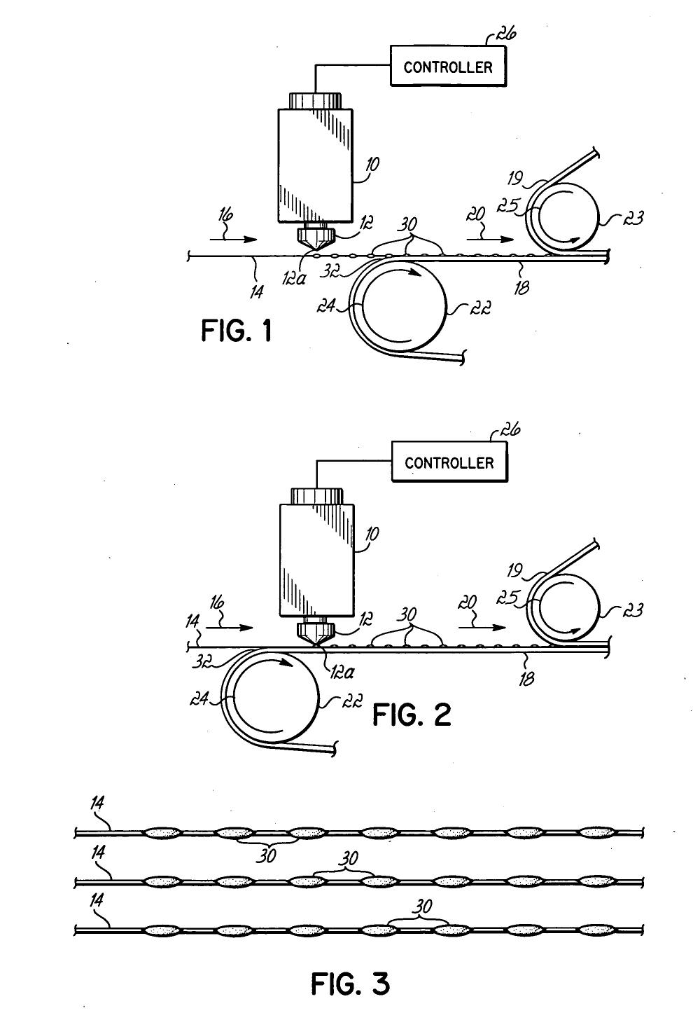

FIG. 1 illustrates one embodiment of the method of this invention which uses an adhesive dispenser 10 including a nozzle 12. Nozzle 12 may include a circular discharge orifice, a more elongate slot-shaped orifice, or other types of orifices suitable for dispensing discrete elongate segments of adhesive. In this embodiment, one or more stretched Lycra strands 14 are moving in the direction of arrow 16 and a flat sheet 18 of substrate material, such as a woven or nonwoven material, is moving in the direction of arrow 20 around a conventional guide cylinder 22 rotating in the direction of arrow 24. Strand 14 is stretched so that, upon attachment to sheet 18, the sheet 18 will be elasticized generally along a line defined by strand 14. Dispenser 10 is operated by a suitable controller 26 for intermittently actuating a valve (not shown) within the dispenser 10. The valve actuates on and off to selectively allow and prevent the flow of adhesive through the nozzle 12. The apex or tip 12a of the nozzle 12 is spaced a short distance from the Lycra strand 14 and accurately dispenses adhesive segments 30 directly onto the strand 14 immediately prior to or upstream from the point 32 where the strand 14 meets the substrate 18. Thus, during the time that it takes for the strand 14 to reach point 32, each adhesive segment 30 will flow around all sides of the strand 14 including the lower side (as viewed in FIG. 1) to ensure full bonding between the strand 14 and the upper surface of the substrate 18. Substrate 18 may then be bonded to a second substrate 19 to sandwich strand 14 therebetween. Substrates 18, 19 may be brought together by a second guide cylinder 23 rotating in the direction of arrow 25.

The frequency of the adhesive segments 30 will depend on the application conditions and needs, however, in one exemplary embodiment, there may be 4-7 elongate segments 30 per inch in a diaper manufacturing application. The adhesive discharge orifice of the nozzle 12 may be circular and generally about 0.010 inch to about 0.020 inch in diameter when a pressure sensitive hot melt adhesive having a viscosity of 1000-4000 centipoise is used at a temperature of 275° F. to 350° F. and a pressure of 400 psi to 800 psi. Of course, many other specific parameters for either the dispenser 10 or nozzle 12, or both, as well as for the adhesive, may be used depending on the application. The distance from the discharge orifice at the apex 12a of the nozzle 12 to the elastic strand 14 may be from about 0.010 inch to about 0.5 inch. Again, however, this distance may also change depending on the needs of the application. One preferred dispenser is the ES400 dispenser available from Nordson Corporation of Westlake, Ohio which uses an electromagnetic coil capable of cycling at a high frequency. As will be appreciated, higher speed production lines will require a higher frequency actuation to achieve the desired spacing of adhesive segments 30 on the elastic strands 14. Using current dispensing valve technology, for example, having a duty cycle of about 3-4 ms, production speeds of 1200 ft./min. and higher may be achieved in carrying out this invention.

FIG. 2 illustrates another method performed in accordance with the inventive principles in which like reference numerals indicate like structure in FIGS. 1 and 3. In this method, the dispenser 10 and, more particularly, the discharge nozzle 12 is positioned upstream of the point 32 of joinder between strand 14 and substrate 18 such that the adhesive segments are dispensed after the Lycra strand(s) 14 have contacted the flat substrate 18. Also, this embodiment illustrates the option of contacting the strand 14 with the apex 12a of the nozzle 12 while intermittently dispensing the elongate segments 30 of adhesive. In this case, the elongate segments 30 of adhesive are dispensed onto the Lycra strand(s) and the upper surface of the flat substrate 18 in a simultaneous fashion. This, as in the first embodiment, forms discrete bond areas between the elastic strand(s) 14 and the mating surface of the substrate 18.

In the embodiments of FIGS. 1 and 2, it will be appreciated that nozzles 12 may be used which dispense only through one discharge orifice or, alternatively, through multiple discharge orifices. In the latter case, for example, each orifice would be positioned adjacent to a corresponding elastic strand 14 such that discrete, separated elongate segments of adhesive 30 would be dispensed onto a corresponding number of elastic strands 14 as, for example, illustrated in the top view of FIG. 3. Alternatively, in the various embodiments of the invention there may be thinner areas of adhesive between adjacent elongate segments 30. For example, this may occur if dispenser 10 is cycled “on” and “off” in such a manner that an adhesive tail is formed between each elongate segment. That is, dispenser 10 might not fully shut off between adhesive segment dispensing cycles. The elongate segments 30 will be more elongated in a direction parallel to the length of the elastic strand(s) 14. This will be the case whether a slot nozzle is used with the length of the slot extending parallel or transverse to the length of the elastic strand(s) 14 as discussed below.

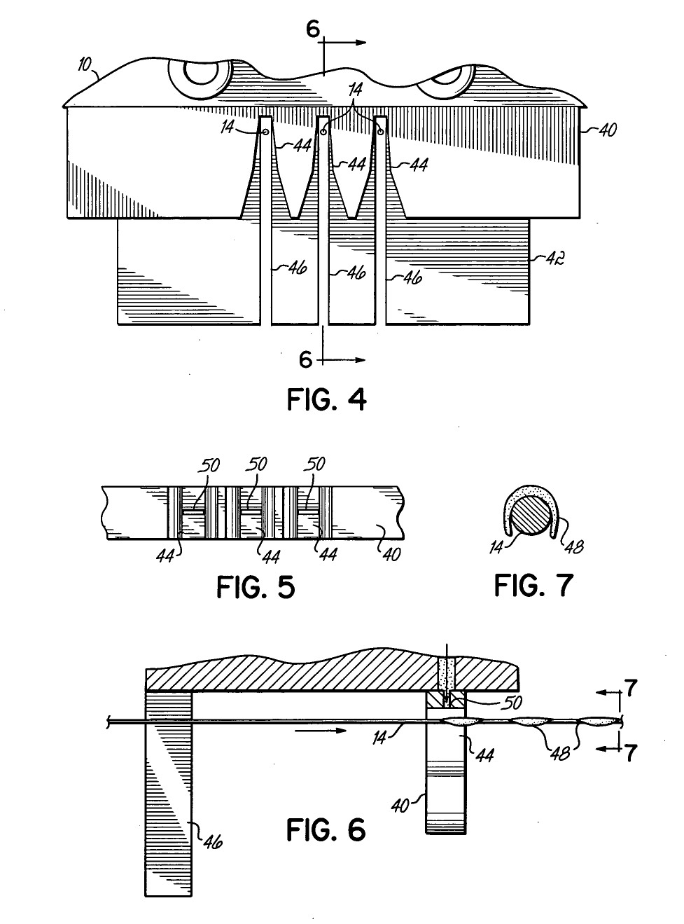

FIGS. 4-6 illustrate another embodiment of the invention utilizing an illustrative slot nozzle 40 including an elastic strand guide 42 for ensuring that the strands 14 are held steady as they move through the respective slots 44 of the nozzle 40. Each strand 14 moves through a slot 46 in the guide 42 and then through a slot 44 in the adhesive discharge nozzle. An intermittently actuated valve (not shown) may be used as discussed in connection with the first embodiment to discharge elongate segments 48 of adhesive onto each strand from elongate openings 50 associated with the respective discharge slots 40. Openings 50 have their lengths oriented transverse to the length of the corresponding strands 14. In this embodiment, the strands 14 are again preferably spaced from the discharge openings 5b as in the first embodiment by a spacing that may be determined according to the application needs. The length of the opening 50 also may be determined by application needs but in this embodiment it is approximately five times the diameter of strand 14.

The dispenser in this embodiment may be the same as dispenser 10 of the first embodiment. Since slot opening 50 is oriented with its lengthwise dimension extending transverse to or across the direction that strand 14 moves, this can better allow the adhesive to flow around the sides of the strand 14, as shown in FIG. 7, resulting in better adhesive contact with substrate 18 (FIGS. 1 and 2).

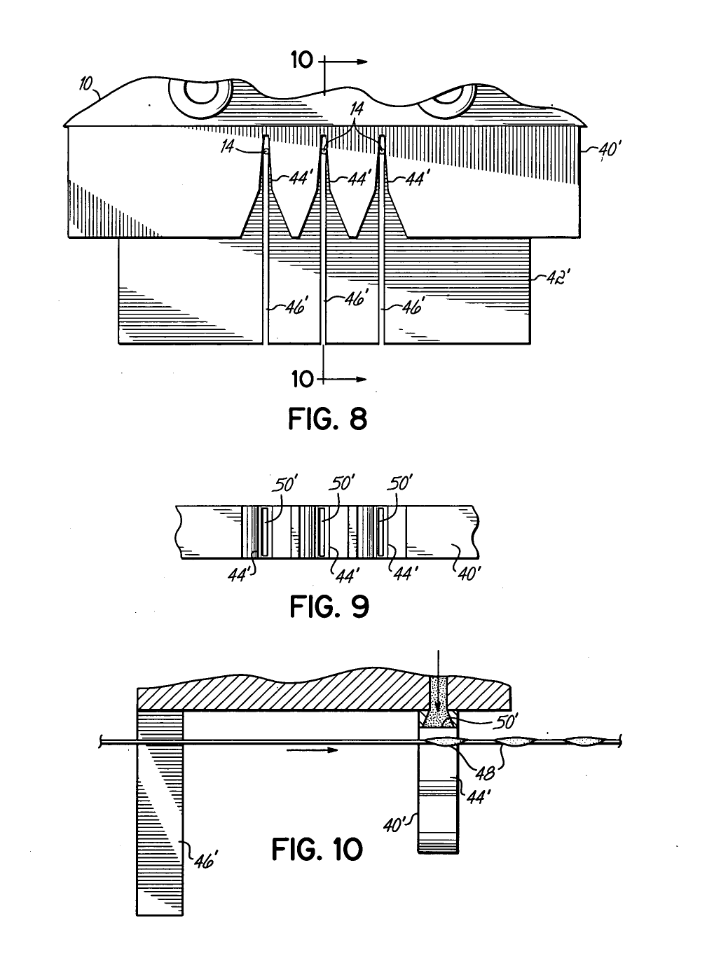

FIGS. 8-10 illustrate another embodiment of the invention in which like reference numerals to FIGS. 4-7 indicate like structure and reference numerals which are the same but have prime marks (′) indicate slightly modified elements relative to those shown in FIGS. 4-6. In this embodiment, an illustrative slot nozzle 40′ includes an elastic strand guide 42′ for ensuring that the strands 14 are held steady as they move through the respective slots 44′ of the nozzle 40′. Each strand 14 moves through a slot 46′ in the guide 42′ and then through a slot 40′ in the adhesive discharge nozzle. An intermittently actuated valve (not shown) may be used as discussed in connection with the first embodiment to discharge elongate dots 48 of adhesive onto each strand from openings 50′ associated with the respective discharge slots 40′. In this embodiment, the strands 14 are again preferably spaced from the discharge openings 50′ as in the first embodiment by a spacing that may be determined according to the application needs. The length of the opening 50′ may be also determined by application needs. The chart below illustrates one preferred set of dimensions for the strand size when, for example, Lycra is used, and the corresponding recommended minimum slot width and discharge orifice width.

Comparison Between Elastic Strand Size and Nozzle Dimensions

| Elastic Strand | | Discharge Orifice |
|---|---|---|
| (Denier) | Slot Width | Width |
| 420 mm | 0.23 mm | 0.20 mm |
| 490 mm | 0.25 mm | 0.23 mm |
| 560 mm | 0.28 mm | 0.25 mm |
| 700 mm | 0.32 mm | 0.30 mm |
| 840 mm | 0.35 mm | 0.30 mm |
| 1120 mm | 0.47 mm | 0.42 mm |

The dispenser in this embodiment may be the same as dispenser 10 of the first embodiment. As shown in the figures, slot opening 50′ may be oriented with its length extending parallel to the corresponding strand 14.

In accordance with the invention, one or more elastic strands are coated with discrete, separated elongate segments of adhesive either before and/or after the strand contacts one surface of the sheet. As the elastic is stretched when applied and bonded to the sheet, the sheet is elasticized along the region of the strand or strands. In addition to contacting the sheet, it will be appreciated that the adhesive should contact enough of the strand to form a sufficient bond between the sheet and the strand. This may involve fully coating all sides of the strand or only partially coating the strand. In the embodiments described above, an additional linear formation of adhesive, such as one applied by a meltblown nozzle, may be applied to the sheet, prior to contact with the strand, to assist with the bond. Elongate segments of adhesive may be applied from only one side of the strand, such as the upper side, or from opposite sides of the strand, such as upper and lower sides. If applied from opposite sides of the strand, the elongate segments may be applied from directly opposite locations such that they contact the same point along the strand, or they may be applied in a staggered format with upper and lower elongate segments of adhesive alternating along the strand. In this manner, it may be possible to apply more elongate segments of adhesive per inch. The number of adhesive dispensers on either or both sides of the strand may be varied according to the needs of the application.

While the present invention has been illustrated by a description of preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims, wherein

We claim:

1. Apparatus for dispensing adhesive onto a strand moving along a strand path, comprising:
an adhesive dispenser capable of receiving adhesive from an adhesive supply and having an upper end and a lower end;
a nozzle coupled to said lower end of said adhesive dispenser and in fluid communication with said adhesive dispenser, said nozzle including an adhesive discharge orifice for discharging the adhesive received from said adhesive dispenser onto the strand moving past said adhesive discharge orifice along the strand path; and
a strand guide mounted at a location beneath said lower end of said adhesive dispenser and upstream of said adhesive discharge orifice along the strand path, said strand guide configured to receive and guide movement of the strand in spaced relation to said adhesive discharge orifice.

2. The apparatus of claim 1, wherein said strand guide comprises an element having a slot for receiving the strand.

3. The apparatus of claim 2, wherein said slot further comprises opposed, parallel side walls.

4. The apparatus of claim 1, wherein said adhesive dispenser further comprises front and rear sides, said front side located upstream of said rear side along the strand path, and said strand guide is positioned adjacent said front side of said adhesive dispenser.

5. The apparatus of claim 1, wherein said nozzle further includes a plurality of adhesive discharge orifices and said strand guide includes a plurality of slots, each of said slots configured to receive and guide movement of one of the strands.

6. Apparatus for dispensing adhesive onto a strand moving along a strand path, comprising:
an adhesive dispenser capable of receiving adhesive from an adhesive supply, said adhesive dispenser having an upper end, a lower end, a front side, and a rear side, said front side located upstream of said rear side along the strand path;
a nozzle coupled to said lower end of said adhesive dispenser and in fluid communication with said adhesive dispenser, said nozzle including an adhesive discharge orifice for discharging the adhesive received from said adhesive dispenser onto the strand moving past said adhesive discharge orifice along the strand path; and
a strand guide mounted at a location directly adjacent said front side of said adhesive dispenser and upstream of said adhesive discharge orifice along the strand path, said strand guide configured to receive and guide movement of the strand in spaced relation to said adhesive discharge orifice.

7. The apparatus of claim 6, wherein said strand guide comprises an element having a slot for receiving the strand.

8. The apparatus of claim 7, wherein said slot further comprises opposed, parallel side walls.

9. The apparatus of claim 6, wherein said nozzle further includes a plurality of adhesive discharge orifices and said strand guide includes a plurality of slots, each of said slots configured to receive and guide movement of one of the strands.

10. A method of dispensing adhesive onto at least one strand from a dispensing nozzle coupled with an adhesive dispenser and having at least one adhesive discharge orifice, comprising:
moving the strand relative to the dispensing nozzle along a strand path;
guiding the strand in spaced relation to the adhesive discharge orifice in a strand guide coupled beneath the adhesive dispenser at a location upstream of the adhesive discharge orifice along the strand path;
dispensing the adhesive from the adhesive discharge orifice toward the strand as the strand moves past the adhesive discharge orifice along the strand path; and
depositing the adhesive on the strand.

11. The method of claim 10, wherein the nozzle further comprises a plurality of adhesive discharge orifices, and further comprising:
moving multiple strands relative to the dispensing nozzle along respective strand paths;
guiding the multiple strands in respective slots in the strand guide;
dispensing the adhesive from respective adhesive discharge orifices toward the strands as the strands move past the adhesive discharge orifices along the respective strand paths; and
depositing the adhesive on the strands.

12. A method of dispensing adhesive onto at least one strand from a dispensing nozzle having at least one adhesive discharge orifice and coupled to an adhesive dispenser having an upper end, a lower end, a front side, and a rear side, the front side located upstream of the rear side along a strand path, comprising:
moving the strand relative to the dispensing nozzle along the strand path;
guiding the strand in spaced relation to the adhesive discharge orifice in a strand guide coupled at a location directly adjacent the front side of the adhesive dispenser and upstream of the adhesive discharge orifice along the strand path;
dispensing the adhesive from the adhesive discharge orifice toward the strand as the strand moves past the adhesive discharge orifice along the strand path; and
depositing the adhesive on the strand.

13. The method of claim 12, wherein the nozzle further comprises a plurality of adhesive discharge orifices, and further comprising:
moving multiple strands relative to the dispensing nozzle along respective strand paths;
guiding the multiple strands in respective slots in the strand guide;
dispensing the adhesive from respective adhesive discharge orifices toward the strands as the strands move past the adhesive discharge orifices along the respective strand paths; and
depositing the adhesive on the strands.
